(19) United States
(12) Patent Application Publication
(10) Pub. No.: US 2023/0017102 A1
(43) Pub. Date: Jan. 19, 2023

(54) ELECTRONIC SYSTEM FOR CONTROLLING AN UNMANNED AIRCRAFT, AND ASSOCIATED METHODS AND COMPUTER PROGRAMS

(71) Applicant: THALES, Courbevoie (FR)

(72) Inventors: Marc RIEDINGER, Toulouse (FR); Philippe FOURNIER, Toulouse (FR)

(21) Appl. No.: 17/782,266

(22) PCT Filed: Dec. 3, 2020
(86) PCT No.: PCT/EP2020/084434

§ 371 Date: Jun. 3, 2022

(30) Foreign Application Priority Data
Dec. 5, 2019 (FR) 1913791

(51) Int. Cl. G05D 1/00; G05D 1/10; B64C 39/02

(52) U.S. Cl. CPC G05D 1/0016; G05D 1/101; B64C 39/024; G05D 1/0044; B64C 2201/146

(57) ABSTRACT

Said control system comprises:
a remote device comprising:
   a remote module for acquiring flight plan data, and
   a remote module for calculating a remote trajectory or a remote setpoint according to the flight plan data;
an on-board device comprising:
   an on-board module for acquiring flight plan data,
   an on-board module for calculating an on-board trajectory or an on-board setpoint according to the data acquired by the on-board acquisition module.

The remote device comprises a module for validating the trajectory which is configured to:
acquire the on-board and remote trajectory or setpoint;
validate or reject the on-board trajectory or setpoint according to the remote trajectory or setpoint;
transmit the result of the validation to the on-board device.

The present invention relates to an electronic system for controlling an unmanned aircraft, the system comprising a remote aircraft flight management device adapted to communicate remotely with the aircraft and at least one on-board aircraft flight management device carried on board the aircraft.

The invention further relates to a remote method for controlling an unmanned aircraft, the method being implemented by a remote flight management device of an electronic system for controlling an unmanned aircraft.

The invention further relates to a computer program comprising software instructions which, when executed by a computer, implement such a remote method for controlling an unmanned aircraft.

The invention further relates to an on-board method for controlling an unmanned aircraft, the method being implemented by an on-board flight management device of an electronic system for controlling an unmanned aircraft.

The invention further relates to a computer program comprising software instructions which, when executed by a computer, implement such an on-board method for controlling an unmanned aircraft.

The invention is in the field of electronic control systems for an unmanned aircraft comprising a remote aircraft flight management device, the remote device preferably being installed in a control station of the aircraft, and comprising an on-board aircraft flight management device, the on-board device being carried on board the aircraft.

In particular, an electronic control system for an unmanned aircraft of the aforementioned type is known, in which the remote flight management device of the aircraft comprises a remote module for acquiring flight plan data and a module for remote calculation of a remote trajectory as a function of the flight plan data acquired by the remote acquisition module and wherein the on-board aircraft flight management device comprises a module for on-board calculation of an on-board trajectory as a function of the flight plan data acquired by the on-board acquisition module. In some cases, the trajectory may be reduced to one or more setpoints such as speed, heading, altitude, thrust, slope, etc. Such setpoint(s) may constitute trajectory elements.

However, such a device is not entirely satisfactory, as it does not ensure sufficient integrity of the on-board trajectory.

The purpose of this invention is to provide an electronic control system for an unmanned aircraft whose on-board trajectory has high integrity.

To this end, the subject matter of the invention is an electronic control system for an unmanned aircraft, the system comprising:
a remote aircraft flight management device adapted to communicate remotely with the aircraft and comprising:
a remote module for acquiring flight plan data, and
a remote module for calculating a remote trajectory or setpoint according to the flight plan data acquired by the remote acquisition module; and
at least one on-board aircraft flight management device carried on board the aircraft, the on-board device comprising:
   an on-board module for acquiring flight plan data, configured to acquire the flight plan data acquired by the remote acquisition module, and
   an on-board module for calculating a remote trajectory or setpoint according to the flight plan data acquired by the on-board acquisition module; the remote device comprising a trajectory validation module configured to:
acquire the on-board trajectory or setpoint and the remote trajectory or setpoint;
validate the on-board trajectory or setpoint or reject the on-board trajectory or setpoint based on the remote trajectory or setpoint; and
transmit the result of the validation to the on-board flight management device.

In other beneficial aspects of the invention, the electronic system for controlling an unmanned aircraft comprises one or more of the following features, taken in isolation or in any technically possible combination:
the validation module comprises a user instruction acquisition unit, the user instruction acquisition unit being configured to acquire instructions from the user and to validate or reject the on-board trajectory or setpoint according to the user instructions;
the validation module comprises a unit for comparing the on-board trajectory or setpoint and the remote trajectory or setpoint, the comparison unit being configured to compare a deviation between the on-board trajectory or setpoint and the remote trajectory or setpoint, and to validate or reject the on-board trajectory or setpoint depending on the deviation of the on-board trajectory or setpoint from the remote trajectory or setpoint compared to a predefined threshold deviation value;
the on-board device comprises a generation module configured to acquire the result of the validation of the trajectory validation module and to generate steering instructions, adapted to be interpreted by an autopilot, according to the result of the validation;
the generation module is further configured to:
   if the on-board trajectory or setpoint is validated by the validation module, generate steering instructions based on the validated on-board trajectory; and
   if the on-board trajectory or setpoint is rejected by the validation module, generate control instructions according to:
      the last validated on-board trajectory or setpoint; or
      an on-board contingency trajectory or setpoint; or
         flight instructions transmitted directly from the remote flight management device;
the system comprises at least three on-board aircraft flight management devices, and wherein the system is configured to select a primary on-board device to generate the flight control instructions, the selection of the primary on-board device being a function of the on-board trajectory or setpoint calculated by each of the on-board devices;
the system comprises at least one complementary remote aircraft flight management device, the complementary remote device comprising:
   a complementary remote acquisition module, configured to acquire the flight plan data acquired by the remote acquisition module, and
   a complementary remote module for calculating a complementary remote trajectory or setpoint according to the flight plan data acquired by the complementary remote acquisition module,

the flight plan data acquired by the on-board acquisition module being provided either by the remote acquisition module or by the complementary remote acquisition module.

The invention further relates to a remote method for controlling an unmanned aircraft, the method being implemented by a remote flight management device of an electronic system for controlling an unmanned aircraft, the method being implemented by a remote flight management device of an electronic system for controlling an unmanned aircraft as previously mentioned, and comprising the following steps:
remote acquisition of flight plan data,
calculation of a remote trajectory or setpoint based on the acquired flight plan data,
transmission of flight plan data to the on-board flight management device,
acquisition of the remote trajectory or setpoint and an on-board trajectory or setpoint, the on-board trajectory or setpoint being transmitted by the on-board flight management device,
validation or rejection of the on-board trajectory or setpoint according to the remote trajectory or setpoint, and
transmission of the result of the validation of the trajectory or on-board setpoint to the on-board device.

A further object of the invention is a computer program comprising software instructions which, when executed by a computer, implement a remote method for controlling an unmanned aircraft as defined above.

The invention further relates to an on-board method for controlling an unmanned aircraft, the method being implemented by an on-board flight management device of an electronic system for controlling an unmanned aircraft, the method being implemented by an on-board flight management device of an electronic system for controlling an unmanned aircraft as previously mentioned, and comprising the following steps:
on-board acquisition of flight plan data transmitted by the remote flight management device,
calculation of a remote trajectory or setpoint based on the acquired flight plan data,
transmission of the on-board trajectory or setpoint to the remote flight management device,
acquisition of a trajectory or setpoint validation result, the result being transmitted by the remote flight management device, and
generation of steering instructions according to the trajectory or setpoint validation result.

A further object of the invention is a computer program comprising software instructions which, when executed by a computer, implement an on-board method for controlling an unmanned aircraft as defined above.

These features and advantages of the invention will appear more clearly upon reading the following description, given solely as a non-limiting example, and made in reference to the attached drawings, in which:

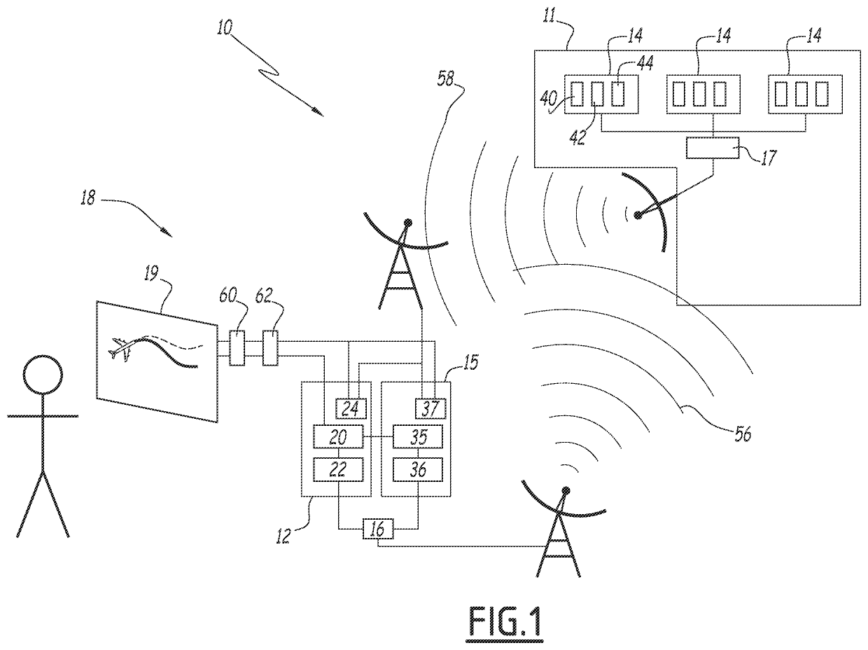

FIG. 1 is a schematic representation of a control station and an unmanned aircraft implementing an electronic system for controlling an unmanned aircraft according to the invention;

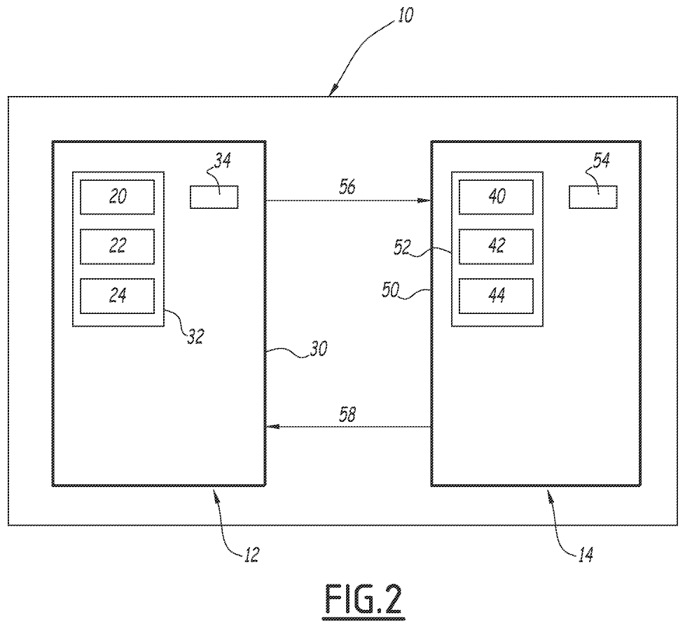

FIG. 2 is a schematic representation of a remote device and an on-board aircraft flight management device of the electronic system for controlling an unmanned aircraft in FIG. 2;

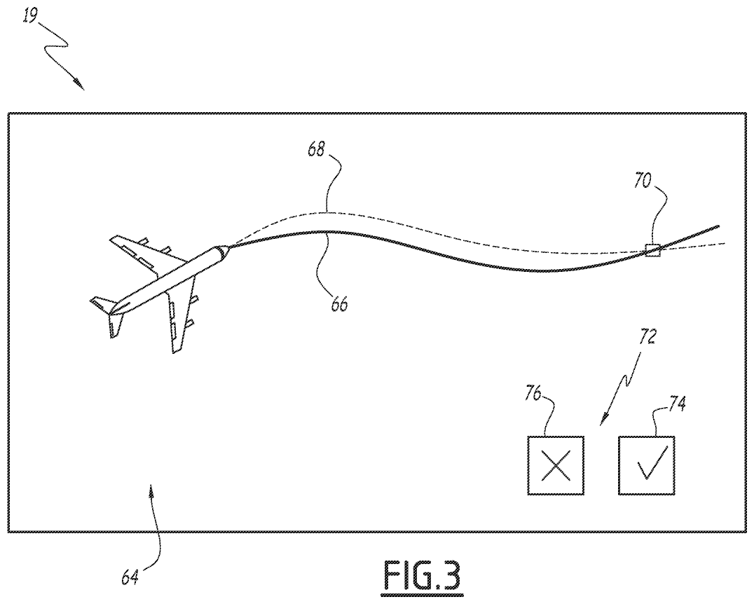

FIG. 3 is a representation of data displayed by a user instruction acquisition unit according to the invention; and

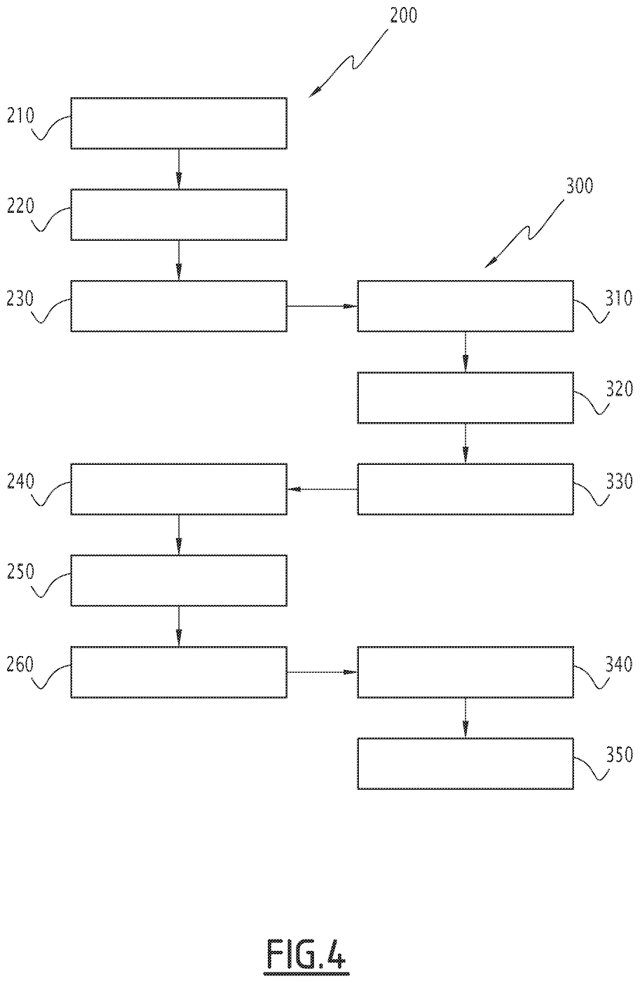

FIG. 4 is a flowchart of the remote and on-board methods for controlling an unmanned aircraft.

An electronic system 10 for controlling an unmanned aircraft 11, hereafter referred to simply as aircraft 11, is shown in FIG. 1. The control system 10 comprises a remote aircraft 11 flight management device 12, at least one on-board aircraft 11 flight management device 14 and preferably a complementary remote aircraft 11 flight management device 15.

The control system 10 preferably comprises a remote control unit 16 and an on-board control unit 17.

In the embodiment shown in FIG. 1, the aircraft 11 comprises three on-board devices 14.

A control station 18 comprises a remote device 12 and a complementary remote device 15 for managing the flight of the aircraft 11.

In the embodiment shown in FIG. 1, the control station 18 comprises a remote control unit 16 and the aircraft 11 comprises an on-board control unit 17.

The unmanned aircraft 11 is preferably an unmanned aeroplane. Alternatively, the unmanned aircraft is an unmanned helicopter.

The control station 18 is preferably a ground control station. Alternatively, the control station 18 is a control station on board a control aircraft.

The control station 18 advantageously comprises a user interface 19. The user interface 19 comprises, for example, information display means and information input means. The user interface comprises, for example, a screen and a keyboard.

Alternatively, the user interface 19 comprises a touch screen.

The remote device 12 is adapted to communicate remotely with the aircraft 11. The remote device 12 comprises a remote module 20 for acquiring flight plan data.

The remote device 12 comprises a remote module 22 for calculating a remote trajectory based on flight plan data acquired by the remote acquisition module 20.

In the embodiment shown in FIG. 1, the remote device 12 comprises a trajectory validation module 24 configured to acquire the remote trajectory and an on-board trajectory transmitted by the on-board device 14, to validate the on-board trajectory or reject the on-board trajectory based on the remote trajectory and to transmit the result of the validation to the on-board device 14. In an alternative and preferred embodiment, the trajectory validation module 24 is separate and independent from the remote device 12.

As shown in FIG. 2, the remote device is a programmable electronic device, for example a computer, and comprises for example an information processing unit 30 formed for example by a memory 32 combined with a processor 34. In addition, the remote device 12 comprises or is connected to a remote radio communication interface, adapted to transmit and receive radio communications. In addition, the remote device 12 is connected to the user interface 19.

In one embodiment, the remote acquisition module 20, the remote calculation module 22 and the trajectory validation module 24, are each in the form of software which can be executed by the processor 34. The memory 32 is then adapted to store remote flight plan data acquisition software, remote software for calculating a trajectory based on the flight plan data acquired by the remote acquisition software, and trajectory validation software configured to acquire the remote trajectory and an on-board trajectory transmitted by the on-board device 14, to validate the on-board trajectory or reject the on-board trajectory based on the remote trajectory and to transmit the validation result to the on-board device 14. The processor 34 of the information processing unit 30 is then able to execute the remote acquisition software, the remote calculation software, and the trajectory validation software.

In one variant, the remote acquisition module 20, remote calculation module 22, and trajectory validation module 24 are each in the form of a programmable logical component, such as a FPGA (Field Programmable Gate Array), or as a dedicated integrated circuit, such as an ASIC (Application-Specific Integrated Circuit).

When the remote device 12 is in the form of one or more software, that is to say in the form of a computer program, it is also capable of being stored on a computer-readable medium, not shown. The computer-readable medium is, for example, a medium that can store electronic instructions and be coupled with a bus from a computer system. For example, the readable medium is an optical disk, magneto-optical disk, ROM memory, RAM memory, any type of non-volatile memory (for example EPROM, EEPROM, FLASH, NVRAM), magnetic card or optical card. The readable medium in such a case stores a computer program comprising software instructions.

The complementary remote device 15 is similar to the previously described remote device 12, is functionally redundant and is used to improve operational safety, for example in the event of a failure.

The complementary remote device 15 comprises a complementary remote acquisition module 35 similar to the remote acquisition module 20, a complementary remote calculation module 36 similar to the remote calculation module 22 and, for example, a trajectory validation module 37 similar to the trajectory validation module 24.

In the remainder of the description, the features of the remote acquisition module 20 apply to the complementary remote acquisition module 35, the features of the remote calculation module 22 apply to the complementary remote calculation module 36, and the features of the trajectory validation module 24 apply to the complementary trajectory validation module 37.

Each on-board device 14 comprises an on-board module 40 for acquiring flight plan data, configured to acquire the flight plan data acquired by the remote acquisition module 20.

Each on-board device 14 comprises an on-board module 42 for calculating an on-board trajectory based on flight plan data acquired by the remote acquisition module 40.

Each on-board device 14 preferably comprises a generation module 44 configured to acquire the result of the validation of the trajectory validation module 24 and to generate steering instructions adapted to be interpreted by an autopilot or flight controls depending on the result of the validation.

As shown in FIG. 2, the on-board device 14 comprises for example an information processing unit 50 formed for example by a memory 52 combined with a processor 54. In addition, the on-board device 14 comprises or is connected to a radio communication interface, adapted to transmit and receive radio communications.

In the example of FIG. 2, the on-board acquisition module 40, the on-board calculation module 42 and preferably the on-board generation module 44, are each in the form of software which can be executed by the processor 54. The memory 52 is then able to store on-board flight plan data acquisition software, on-board calculation software for an on-board trajectory depending on the flight plan data acquired by the on-board acquisition software, and generation software configured to acquire the result of the validation from the trajectory validation module 24 and to generate steering instructions adapted to be interpreted by an autopilot or flight controls depending on the result of the validation. The processor 54 of the information processing unit 50 is then able to execute the on-board acquisition software, the on-board calculation software, and the generation software.

In a variant not shown, the on-board acquisition module 40, the on-board calculation module 42, and the generation module 44 are each in the form of a programmable logical component, such as a FPGA (Field Programmable Gate Array), or as a dedicated integrated circuit, such as an ASIC (Application-Specific Integrated Circuit).

When the on-board device is in the form of one or more software, that is to say in the form of a computer program, it is also capable of being stored on a computer-readable medium, not shown. The computer-readable medium is, for example, a medium that can store electronic instructions and be coupled with a bus from a computer system. For example, the readable medium is an optical disk, magneto-optical disk, ROM memory, RAM memory, any type of non-volatile memory (for example EPROM, EEPROM, FLASH, NVRAM), magnetic card or optical card. The readable medium in such a case stores a computer program comprising software instructions.

The remote acquisition module 20 is configured to acquire flight plan data, for example to acquire flight plan data entered by a user.

The remote acquisition module 20 is advantageously connected to the user interface 19 and is configured to acquire flight plan data entered through the user interface 19. Alternatively, the remote acquisition module 20 is configured to acquire flight plan data stored on a memory external to the control system 10, for example designated via the user interface 19.

The flight plan data acquired by the remote acquisition module 20 corresponds, for example, to desired waypoints of the aircraft 11. In particular, the flight plan data comprises coordinates of a departure and arrival airport, departure and arrival procedures, turning points and flight routes. The flight plan data further comprises, for example, mass, centre of gravity, fuel, flight level, and meteorological parameters.

The remote acquisition module 20 is configured to transmit the flight plan data to the on-board acquisition module 40, for example via a radio transmission, such as a command radio transmission 56, as shown in FIG. 1.

The remote acquisition module 20 is for example configured to transmit the flight plan data to the complementary remote acquisition module 35.

The remote control unit 16 is configured to select the remote device used from the remote device 12 and the complementary remote device 15. The remote control unit 16 is for example configured to select the remote device 12 as the default remote device. In the event of failure of the remote device 12, since the function and structure of the complementary remote device 15 are similar to the function and structure of the remote device 12, the control unit 16 is configured to select the complementary remote device 15 as the remote device to be used. The remote control unit 16 is preferably configured to detect a failure of the remote device 12 autonomously and to automatically select the complementary remote device 15 as the remote device in use.

The remote calculation module 22 is configured to calculate a trajectory in three spatial dimensions and one temporal dimension that is flyable by the aircraft 11.

In particular, the remote calculation module 22 is configured to calculate a remote trajectory composed of straight segments and circular arcs consistent with the performance of the aircraft 11. The trajectory is in particular dependent on the position of the aircraft, its speed, and also on data external to the aircraft such as weather data.

The remote calculation module 22 is configured to transmit the remote trajectory to the trajectory validation module 24.

The on-board acquisition module 40 is configured to receive flight plan data from the remote acquisition module 20, for example via the control radio transmission 56.

The on-board calculation module 42 is configured to calculate an on-board trajectory in three spatial dimensions and one temporal dimension that is flyable by the aircraft 11.

In particular, the on-board calculation module 42 is configured to calculate a trajectory composed of straight segments and circular arcs consistent with the performance of the aircraft 11. The trajectory is in particular dependent on the position of the aircraft, its speed, and also on data external to the aircraft such as weather data.

The on-board calculation module 42 is configured to calculate a trajectory following the same conventions as the trajectory calculated by the remote calculation module 22.

The on-board control unit 17 is advantageously configured to compare the calculations of the on-board devices 14 with each other. This comparison can be done by comparing each of the on-board trajectories calculated by each of the on-board calculation modules 42 of the on-board devices 14. The on-board control unit 17 is for example configured to calculate the average deviation between each of the trajectories calculated by each of the on-board calculation modules 42. The on-board control unit 17 is then configured to determine whether or not a calculated trajectory is relevant based on the average deviation of that trajectory from other calculated trajectories. In particular, the on-board control unit 17 is configured to determine a trajectory as irrelevant if the average deviation from all other calculated trajectories is significant. The on-board control unit 17 is configured to determine a trajectory as relevant if the average deviation from at least one other calculated trajectory approaches zero. The on-board control unit 17 is for example configured to select an on-board device 14 as the primary device as long as the trajectory generated by said on-board device 14 is relevant. The on-board control unit 17 is for example configured to change the primary device as soon as the trajectory generated by the primary on-board device 14 is irrelevant. In particular, the on-board control unit 17 is then configured to select an on-board device 14 that calculates a relevant trajectory

Alternatively, the comparison of the calculations of the on-board devices 14 can be done by comparing each of the setpoints produced by the generation modules 44 of each of the on-board devices 14. The on-board control unit 17 is then configured to determine whether or not a setpoint produced by the generation modules 44 is relevant based on the deviation of that setpoint from the setpoints of the other on-board devices. For example, a roll command from the generation module 44 will be invalid if the deviation from the other roll commands is greater than 5 degrees for 3 seconds.

The choice of the primary on-board device is then a function of the on-board trajectory of each of the on-board devices 14. The on-board calculation module 42 of the primary device is then configured to transmit the on-board trajectory to the trajectory validation module 24. The on-board calculation module 42 is for example configured to transmit the on-board trajectory to the trajectory validation module 24 via a control radio transmission 58.

According to a first embodiment, the trajectory validation module 24 comprises a unit 60 for acquiring instructions from a user.

In a second embodiment, the trajectory validation module 24 comprises a unit 62 for comparing the on-board trajectory and the remote trajectory.

In a third embodiment, the trajectory validation module 24 comprises both a unit 60 for acquiring instructions from a user and a unit 62 for comparing the on-board trajectory and the remote trajectory.

The user instruction acquisition unit 60 is configured to acquire instructions from the user and to validate or reject the on-board trajectory based on the user instructions.

The instruction acquisition unit 60 is for example connected to the user interface 19. In particular, the instruction acquisition unit 60 is configured to generate interface data 64 and acquire instructions entered by the user through the user interface 19.

In particular, the instruction acquisition unit 60 is configured to generate interface data 64 for transmission to the user interface 19.

As illustrated in FIG. 3, the interface data 64 includes for example displayable data such as remote trajectory data 66, on-board trajectory data 68, and flight plan data 70.

In the embodiment shown in FIG. 3, the user interface 19 is a touch screen. The interface data 64 then comprises control data 72 comprising validation data 74 and rejection data 76.

The instruction acquisition unit 60 is then configured to validate the on-board trajectory when the user interacts with the validation data 74 and to reject the on-board trajectory when the user interacts with the rejection data 76.

The instruction acquisition unit 60 is, for example, configured to transmit the result of the validation to the on-board device 14.

The on-board trajectory and remote trajectory comparison unit 62 is configured to compare the deviation between the on-board trajectory and the remote trajectory, and to validate or reject the on-board trajectory as a function of the deviation between the on-board trajectory and the remote trajectory from a pre-defined threshold deviation value.

The comparison unit 62 is for example configured to compare the deviation between the on-board trajectory and the remote trajectory by calculating the error between the on-board trajectory and the remote trajectory. The error calculated by the comparison unit 62 corresponds, for example, to a standard deviation value between points of the calculated on-board trajectory and the remote trajectory. The comparison unit 62 is for example configured to reject the on-board trajectory when the error exceeds a critical threshold value.

Alternatively, the comparison unit 62 is for example configured to compare the deviation between the on-board trajectory and the remote trajectory by calculating the maximum deviation, i.e. the maximum distance, between the remote trajectory and the on-board trajectory. The comparison unit 62 is for example configured to reject the on-board trajectory when the maximum deviation exceeds a predefined deviation threshold value. The predefined deviation threshold value is, for example, in this embodiment equal to 10 m for a straight trajectory geographically referenced in the database or 40 m for a curved trajectory geographically referenced in the database. It will be higher if the trajectory is not geo-referenced in the database or if the performance level of a procedure does not require it.

According to the third embodiment in which the validation module 24 comprises both the instruction acquisition unit 60 and the comparison unit 62, the comparison unit 62 is for example configured to perform a first validation by validating or rejecting the on-board trajectory depending on the remote trajectory as described above. The comparison unit is then adapted to transmit the trajectory validated a first time by the comparison unit 62 to the instruction acquisition unit 60, the instruction acquisition unit then being configured to validate or reject the trajectory validated by the comparison unit 62 according to the user's instructions.

The trajectory validation module 24 is configured to transmit the result of the validation to the on-board flight management device 14, for example to the on-board control unit 17 or to the generation module 44.

The trajectory validation module 24 is for example configured to transmit validation data to the on-board device 14 when the on-board trajectory is validated. Alternatively, the trajectory validation module 24 is configured to transmit no data when the on-board trajectory 14 is validated.

The trajectory validation module 24 is for example configured to transmit rejection data to the on-board device 14 when the on-board trajectory is rejected. Alternatively or additionally, the trajectory validation module 24 is configured to transmit alternative data to the on-board device. The data transmitted by the trajectory validation module 24 to the on-board device 14 is, for example, transmitted via the control radio transmission 56.

The generation module 44 is configured to generate steering instructions based on a trajectory. In particular, the generation module 44 is configured to generate instructions such as angle instructions for the moving surfaces of the aircraft 11 or thrust instructions for the thrusters of the aircraft 11. The generation module is configured to generate control instructions from the validation result transmitted by the validation module 24.

The generation module 44 is configured to acquire the validation result transmitted by the validation module 24.

The generation module 44 is configured to, if the on-board trajectory is validated by the validation module 24, generate steering instructions based on the validated on-board trajectory.

The generation module 44 is then for example configured to generate steering instructions directly as a function of the on-board calculation module 42, and for example as a function of the on-board trajectory calculated by the on-board calculation module 42 of the remote device 12 chosen as the primary on-board device by the on-board control unit 17.

The generation module 44 is configured to, if the on-board trajectory is rejected by the validation module 24, generate steering instructions as a function of the last validated on-board trajectory stored in the memory 52, or depending on a contingency on-board trajectory, or depending on steering instructions directly transmitted from the remote flight management device 12.

The generation module 44 is configured, for example, to generate steering instructions from the last validated on-board trajectory of the on-board calculation module 42 of the primary on-board device 14, following receipt of a rejection data from the validation module 24.

Alternatively or additionally, the generation module 44 is for example configured to, if the on-board trajectory is rejected by the validation module 24, generate flight instructions based on a contingency trajectory stored in the aircraft 11, prerecorded or received from the remote device 12. Such a contingency trajectory is for example the trajectory of a flight to a predetermined base airport or the trajectory of a holding pattern.

Alternatively or additionally, the generation module 44 is for example configured to, if the on-board trajectory is rejected by the validation module 24, generate steering instructions based on instructions directly entered by the user via the user interface 19, and received from the remote device 12 via the control radio transmission 56.

FIG. 4 shows the steps of a remote method 200 for controlling an unmanned aircraft 11, preferably implemented by a remote device 12 as previously described, and the steps of an on-board method 300 for controlling an unmanned aircraft 11, preferably implemented by an on-board device 14, as previously described.

In a remote flight plan data acquisition step 210 of the remote method 200, the remote acquisition module 20 acquires flight plan data. This flight plan data is for example acquired by the remote acquisition module via the user interface 19.

Following the acquisition step 210, the remote calculation module 22 calculates, in a remote trajectory calculation step 220 of the remote method 200, a remote trajectory. In particular, the remote calculation module 22 calculates the remote trajectory based on the flight plan data acquired by the remote acquisition module 20 in the remote flight plan data acquisition step 210.

Following the step 220 of calculating a remote trajectory, or alternatively, before or during the calculation step 220, the remote device 12 transmits the flight plan data, acquired in the acquisition step 210, to the on-board device 14 in a flight plan data transmission step 230 of the remote method 200. The transmission is for example a radio transmission, such as the radio control transmission 56.

Following the transmission step 230, the on-board acquisition module 40 acquires the flight plan data acquired in step 210 in an on-board flight plan data acquisition step 310 of the on-board method 300.

Following the on-board acquisition step 310, the remote calculation module 22 calculates an on-board trajectory in an on-board trajectory calculation step 320 of the on-board method 300.

Following the on-board trajectory calculation step 320, the on-board device transmits the on-board trajectory calculated in step 320 in an on-board trajectory transmission step 330 of the on-board method 300. The transmission is for example a radio transmission, such as the radio control transmission 58. In the embodiment where multiple on-board devices 14 each calculate an on-board trajectory, the on-board trajectory of the primary on-board module 14 is, for example, transmitted to the remote device 12 in the on-board trajectory transmission step 330.

Following the on-board trajectory calculation step 320, the validation module 24 acquires the remote trajectory, calculated in the remote trajectory calculation step 220, as well as the on-board trajectory, calculated in the on-board trajectory calculation step 320. The validation module 24 acquires the remote and on-board trajectories in a step 240 of acquiring the remote trajectory and the on-board trajectory of the remote method 200.

Following the step of acquiring 240 the remote trajectory and the on-board trajectory, the validation module validates or rejects the on-board trajectory depending on the remote trajectory during a step of validating or rejecting the on-board trajectory 250 of the remote method 200. In this step, the user instruction acquisition unit 60 and/or the comparison unit 62 provide a validation or rejection of the on-board trajectory.

Following the step 250 of validating or rejecting the on-board trajectory, the remote device 12 transmits the result of the validation or rejection step 250 in a validation result transmission step 260 of the remote method 200. During the step 260 of transmitting the result of the validation, the validation module 24 is for example configured to transmit a validation data or no data if the on-board trajectory is validated. During the step 260 of transmitting the result of the validation, the validation module is for example configured to transmit a rejection data if the on-board trajectory is rejected. The transmission is for example a radio transmission, such as the radio control transmission 56.

Following the step 260 of transmitting the trajectory result, the generation module 44 acquires the trajectory validation result transmitted in step 260. The generation module 44 acquires this result in a step 340 of acquiring a trajectory validation result of the on-board method 300.

Following the step 340 of acquiring a trajectory validation result, the generation module 44 generates steering instructions in a step 350 of generating steering instructions for the on-board method 300. During this step, the generation module 44 generates steering instructions according to the validated trajectory if the on-board trajectory is validated during the step 250 of validating or rejecting the on-board trajectory. During this step, and if the on-board trajectory is rejected during the step 250 of validating or rejecting the on-board trajectory, the generation module 44 generates steering instructions according to the last validated on-board trajectory, a contingency on-board trajectory or steering instructions directly transmitted from the remote device 16.

Advantageously, the electronic system 10 for controlling an on-board unmanned aircraft and the remote 200 and on-board 300 methods for controlling an unmanned aircraft ensure a high integrity of the on-board trajectory, in particular thanks to the validation of an on-board trajectory calculated in the on-board unmanned aircraft depending on a distance trajectory calculated in a control station.

In particular, the validation module 24 is particularly advantageous for improving the integrity of the on-board trajectory as it allows a trajectory calculated in the aircraft 11 to be compared with a trajectory calculated outside the aircraft 11 to verify that these trajectories are similar, according to a predefined threshold deviation value.

A validation module 24 comprising a user instruction acquisition unit 60 is particularly advantageous as it allows for a check of the trajectory embarked by a user outside the aircraft, thus ensuring that the trajectory embarked in the aircraft 11 is in accordance with the user's expectations.

A validation module 24 comprising a comparison unit 62 is advantageous as it facilitates the verification of the on-board trajectory and limits human error when checking the on-board trajectory.

The generation module 44 configured to acquire the validation result from the validation module 24 allows the aircraft to follow a trajectory that has been approved by the user. The choice of the approved trajectory from a validated trajectory, a previously validated trajectory, a contingency trajectory or a trajectory directly generated by flight instructions transmitted from the remote flight management device 12 is particularly advantageous in improving the availability and integrity of the on-board trajectory when the trajectory is rejected by the validation module 24.

The use of three on-board devices is particularly advantageous in improving the availability and integrity of the on-board trajectory, ensuring in particular that a trustworthy trajectory is provided to the autopilot or flight controls.

A complementary remote device 15 is also advantageous as it allows redundancy of the ground equipment, improving the availability of this on-board trajectory from the remote device which allows its integrity to be verified.

1. An electronic system for controlling an unmanned aircraft, the system comprising:
a remote device for managing the flight of an aircraft, adapted to communicate remotely with the aircraft and comprising:
a remote module for acquiring flight plan data, and
a remote module for calculating a remote trajectory or setpoint according to the flight plan data acquired by the remote acquisition module; and
at least one on-board device for managing the flight of the aircraft, carried on board the aircraft, the on-board device comprising:
an on-board module for acquiring flight plan data, configured to acquire the flight plan data acquired by the remote acquisition module, and
an on-board module for calculating a remote trajectory or setpoint according to the flight plan data acquired by the on-board acquisition module;
wherein the remote device comprises a trajectory validation module configured to:
acquire the on-board trajectory or setpoint and the remote trajectory or setpoint;
validate the on-board trajectory or setpoint or reject the on-board trajectory or setpoint based on the remote trajectory or setpoint; and
transmit the result of the validation to the on-board flight management device.

2. The system according to claim 1, wherein the validation module comprises a user instruction acquisition unit, the user instruction acquisition unit being configured to acquire instructions from the user and to validate or reject the on-board trajectory or setpoint according to the user instructions.

3. The system according to claim 1, wherein the validation module comprises a unit for comparing the on-board trajectory or setpoint and the remote trajectory or setpoint, the comparison unit being configured to compare a deviation between the on-board trajectory or setpoint and the remote trajectory or setpoint, and to validate or reject the on-board trajectory or setpoint depending on the deviation of the on-board trajectory or setpoint from the remote trajectory or setpoint compared to a predefined threshold deviation value.

4. The system according to claim 1, wherein the on-board device comprises a generation module configured to acquire the result of the validation of the trajectory validation module and to generate steering instructions, adapted to be interpreted by an autopilot, according to the result of the validation.

5. The system according to claim 4, wherein the generation module is further configured to:
if the on-board trajectory or setpoint is validated by the validation module, generate steering instructions based on the validated on-board trajectory; and
if the on-board trajectory or setpoint is rejected by the validation module, generate control instructions depending on:
the last validated on-board trajectory or setpoint; or
an on-board contingency trajectory or setpoint; or
flight instructions transmitted directly from the remote flight management device.

6. The system according to claim 4, wherein the system comprises at least three on-board devices for managing the flight of an aircraft, and wherein the system is configured to select a primary on-board device to generate the flight control instructions, the selection of the primary on-board device depending on the on-board trajectory or setpoint calculated by each of the on-board devices.

7. The system according to claim 1, wherein the system comprises at least one complementary remote device for managing the flight of an aircraft, the complementary remote device comprising:
a complementary remote acquisition module, configured to acquire the flight plan data acquired by the remote acquisition module, and
a complementary remote module for calculating a complementary remote trajectory or setpoint according to the flight plan data acquired by the complementary remote acquisition module,
the flight plan data acquired by the on-board acquisition module being provided either by the remote acquisition module or by the complementary remote acquisition module.

8. A remote method for controlling an unmanned aircraft, the method being implemented by a remote flight management device of an electronic system for controlling an unmanned aircraft according to claim 1, and comprising the following steps:
remote acquisition of flight plan data,
calculation of a remote trajectory or setpoint based on the acquired flight plan data,
transmission of flight plan data to the on-board flight management device,
acquisition of the remote trajectory or setpoint and an on-board trajectory or setpoint, the on-board trajectory or setpoint being transmitted by the on-board flight management device,
validation or rejection of the on-board trajectory or setpoint according to the remote trajectory or setpoint, and
transmission of the result of the validation of the trajectory or on-board setpoint to the on-board device.

9. A computer program comprising software instructions which, when executed by a computer, at least implement a remote method for controlling an unmanned aircraft according to claim 8.

10. A remote method for controlling an unmanned aircraft, the method being implemented by a remote flight management device of an electronic system for controlling an unmanned aircraft according to claim 1, and comprising the following steps:
on-board acquisition of flight plan data transmitted by the remote flight management device,
calculation of a remote trajectory or setpoint based on the acquired flight plan data,
transmission of the on-board trajectory or setpoint to the remote flight management device,
acquisition of a trajectory or setpoint validation result, the result being transmitted by the remote flight management device, and
generating steering instructions according to the trajectory or setpoint validation result.

11. A computer program comprising software instructions which, when executed by a computer, at least implement an on-board method for controlling an unmanned aircraft according to claim 9.
